(19) United States
(12) Patent Application Publication
(10) Pub. No.: US 2014/0211920 A1
(43) Pub. Date: Jul. 31, 2014

(54) STRUCTURE AND METHOD FOR MANUFACTURING THE SAME

(71) Applicants: Yutaka Setomoto, Tokyo (JP); Takayuki Teshima, Yokohama-shi (JP)

(72) Inventors: Yutaka Setomoto, Tokyo (JP); Takayuki Teshima, Yokohama-shi (JP)

(73) Assignee: CANON KABUSHIKI KAISHA, Tokyo (JP)

(21) Appl. No.: 14/342,756

(22) PCT Filed: Aug. 7, 2012
(86) PCT No.: PCT/JP2012/005008

§ 371 Date: Mar. 4, 2014

(30) Foreign Application Priority Data
Sep. 5, 2011 (JP) 2011-192816
Jul. 11, 2012 (JP) 2012-155512

(51) Int. Cl. G01N 23/20; C25D 1/00

(52) U.S. Cl. CPC G01N 23/20; C25D 1/00
USPC 378/70; 205/76; 204/242

(57) ABSTRACT

A method for manufacturing a structure by using a silicon mold, in which disturbances in arrangement due to charges are reduced, can be provided.

The method for manufacturing a structure includes the steps of forming a recessed portion in a silicon substrate, cleaning, drying, or conveying the silicon substrate while charges of a plurality of portions sandwiched between the recessed portion are removed, and filling a metal into the recessed portion of the silicon substrate subjected to the cleaning, drying, or conveying.

### TECHNICAL FIELD

The present invention relates to a structure. In particular, the present invention relates to a structure for an X-ray phase contrast imaging apparatus.

### BACKGROUND ART

A grating made from a structure having a periodic structure is used as a spectral element for various apparatuses. In particular, a grating formed from a structure made from a metal having a high X-ray absorbance characteristic is used in the fields of the nondestructive inspection of objects and medical care.

One purpose of the structure made from a metal having a high X-ray absorbance characteristic is a shield grating of an imaging apparatus to pick up an image by using X-ray Talbot interferometry. The imaging method by using the X-ray Talbot interferometry (X-ray Talbot interference method) is one of imaging methods (X-ray phase imaging methods) taking advantage of X-ray phase contrast.

The X-ray Talbot interference method will be described briefly. In general imaging apparatus to execute the X-ray Talbot interference method, X-rays, which can interfere spatially, pass through an object and a diffraction grating to diffract the X-rays, so as to form an interference pattern. A shield grating to periodically screen out the X-rays is disposed at the position at which the interference pattern is formed, so as to form a moire. The resulting moire is detected with a detector and a pickup image is obtained by using the detection result.

A general shield grating for the X-ray Talbot interference method will be described. In the shield grating, X-ray screening portions (hereafter simply referred to as screening portions) and X-ray transmission portions (hereafter simply referred to as transmission portions) are arranged at a pitch of about 2 to 8 micrometers depending on the resolution required of the imaging. The screening portion has an aspect ratio, that is, the ratio of the height to the width (width in the direction of arrangement of the screening portions and the transmission portions), of about 30 or more and is made from a material, e.g., gold, having high X-ray absorbance. In a favorable method for producing a shield grating having a screening portion made from gold, a mold is produced from silicon having excellent mechanical strength and exhibiting relative easiness in working at a high aspect ratio, and gold is filled therein with plating. However, in production of a mold having a high aspect ratio, it is known that in a drying step after a wet treatment, e.g., Wet cleaning or development, arrangement may be disturbed by mutual sticking of convex portions (or portions sandwiched between a recessed portion) of the mold due to the surface tension of the droplet. If the arrangement of the mold is disturbed, the arrangement of a metal structure obtained by filling the metal is disturbed. In PTL 1, the surface tension during drying is reduced by using supercritical CO₂ and, thereby, mutual sticking of convex portions (or portions sandwiched between the recessed portion) of the mold having a high aspect ratio.

### CITATION LIST

### Patent Literature

PTL 1: Japanese Patent Laid-Open No. 2000-223467

### SUMMARY OF INVENTION

### Technical Problem

The mutual sticking of convex portions (or portions sandwiched between the recessed portion) of the mold due to the surface tension of the droplet can be reduced by using the method described in PTL 1. However, the present inventors found a new problem in that sticking sometimes occurred because of another factor depending on the aspect ratio of a portion to be filled with a metal of the mold. It was found that an oxide film on the silicon surface of the mold having a high aspect ratio was charged because of friction and the like against a medium during supercritical drying, and sometimes mutual sticking of convex portions (or portions sandwiched between the recessed portion) of the mold occurred because of this charge. Likewise, it was found that sometimes mutual sticking of convex portions (or portions sandwiched between the recessed portion) of the mold occurred because of charges in the steps of, for example, plasma cleaning, drying after Wet cleaning, and conveying other than the supercritical drying step.

The present invention provides a silicon mold in which disturbances in arrangement of convex portions (or portions sandwiched between the recessed portion) of the mold are reduced than ever by reducing mutual sticking of convex portions (or portions sandwiched between a recessed portion) of the mold due to charges than ever, a method for manufacturing a structure by using the silicon mold, and a high-aspect ratio structure in which disturbances in arrangement are reduced.

### Solution to Problem

A method for manufacturing a structure, according to an aspect of the present invention, includes the steps of forming a recessed portion in a silicon substrate, cleaning, drying, or conveying a silicon substrate while charges of a plurality of portions sandwiched between the recessed portion are removed, and filling a metal into the recessed portion of the silicon substrate subjected to the cleaning, drying, or conveying.

Other aspects of the present invention will be made clear by the embodiments described below.

### Advantageous Effects of Invention

A silicon mold in which disturbances in arrangement due to charges are reduced, a method for manufacturing a structure by using the silicon mold, and a high-aspect ratio silicon mold and a structure, in which disturbances in arrangement are reduced, can be provided.

### BRIEF DESCRIPTION OF DRAWINGS

FIG. 1 is a an arrangement diagram, where a structure according to a first embodiment of the present invention is incorporated in an X-ray phase imaging system.

FIG. 2A is a diagram for explaining a method for manufacturing the structure according to the first embodiment of the present invention.

FIG. 2B is a diagram for explaining the method for manufacturing the structure according to the first embodiment of the present invention.

FIG. 2C is a diagram for explaining the method for manufacturing the structure according to the first embodiment of the present invention.

FIG. 2D is a diagram for explaining the method for manufacturing the structure according to the first embodiment of the present invention.

FIG. 2E is a diagram for explaining the method for manufacturing the structure according to the first embodiment of the present invention.

FIG. 2F is a diagram for explaining the method for manufacturing the structure according to the first embodiment of the present invention.

FIG. 2G is a diagram for explaining the method for manufacturing the structure according to the first embodiment of the present invention.

FIG. 2H is a diagram for explaining the method for manufacturing the structure according to the first embodiment of the present invention.

FIG. 2I is a diagram for explaining the method for manufacturing the structure according to the first embodiment of the present invention.

FIG. 2J is a diagram for explaining the method for manufacturing the structure according to the first embodiment of the present invention.

FIG. 2K is a diagram for explaining the method for manufacturing the structure according to the first embodiment of the present invention.

FIG. 3A is a diagram for explaining a structure according to a third embodiment of the present invention.

FIG. 3B is a diagram for explaining the structure according to the third embodiment of the present invention.

FIG. 3C is a diagram for explaining the structure according to the third embodiment of the present invention.

FIG. 3D is a diagram for explaining the structure according to the third embodiment of the present invention.

FIG. 3E is a diagram for explaining the structure according to the third embodiment of the present invention.

FIG. 3F is a diagram for explaining the structure according to the third embodiment of the present invention.

FIG. 3G is a diagram for explaining the structure according to the third embodiment of the present invention.

FIG. 3H is a diagram for explaining the structure according to the third embodiment of the present invention.

FIG. 4 is a diagram for explaining a structure according to a fourth embodiment of the present invention.

FIG. 5A is a diagram for explaining a method for manufacturing a structure according to a fifth embodiment of the present invention.

FIG. 5B is a diagram for explaining the method for manufacturing the structure according to the fifth embodiment of the present invention.

FIG. 5C is a diagram for explaining the method for manufacturing the structure according to the fifth embodiment of the present invention.

FIG. 6A is a diagram for explaining a method for manufacturing a structure according to a modified example of the fifth embodiment of the present invention.

FIG. 6B is a diagram for explaining the method for manufacturing the structure according to the modified example of the fifth embodiment of the present invention.

FIG. 6C is a diagram for explaining the method for manufacturing the structure according to the modified example of the fifth embodiment of the present invention.

### DESCRIPTION OF EMBODIMENTS

### First Embodiment

In a first embodiment, a method for manufacturing a two-dimensional structure will be described. The two-dimensional structure produced according to the present embodiment can be used as a two-dimensional shield grating in an X-ray Talbot interference method.

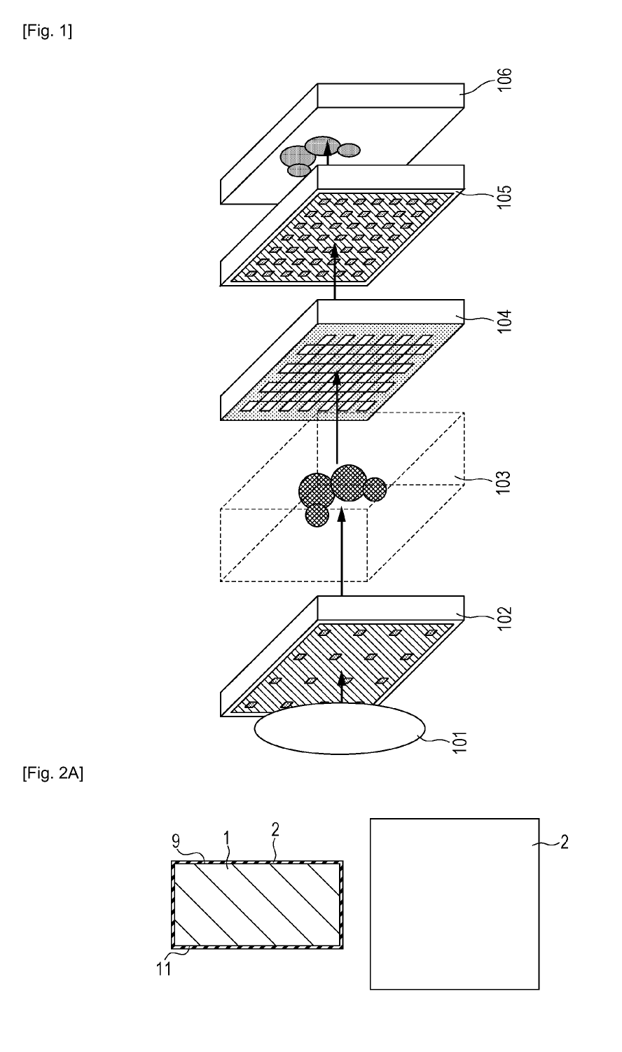

FIG. 1 is a schematic diagram of an imaging apparatus, in which a structure produced according to the present embodiment is used as a shield grating 105, to execute the X-ray Talbot interference method. The X-rays applied from an X-ray source 101 are limited to a predetermined size by a source grating 102 and are applied to an object 103. The X-rays passed through the object 103 are diffracted by a diffraction grating 104 and form an interference pattern on the shield grating 105. The shield grating 105 screens out part of the X-rays to form the interference pattern and form a moire. In this regard, the moire includes those having infinite or nearly infinite periods as well. The moire formed after passing through the shield grating 105 has undergone phase modulation due to the object 103. Therefore, the information of the object can be obtained by detecting the moire with a detector 106. As described above, the shield grating 105 is arranged before the detector 106 and has a function of screening out the X-rays partly and passing the X-rays into the detector 6. Meanwhile, the object 103 may be arranged between the diffraction grating 104 and the shield grating 105.

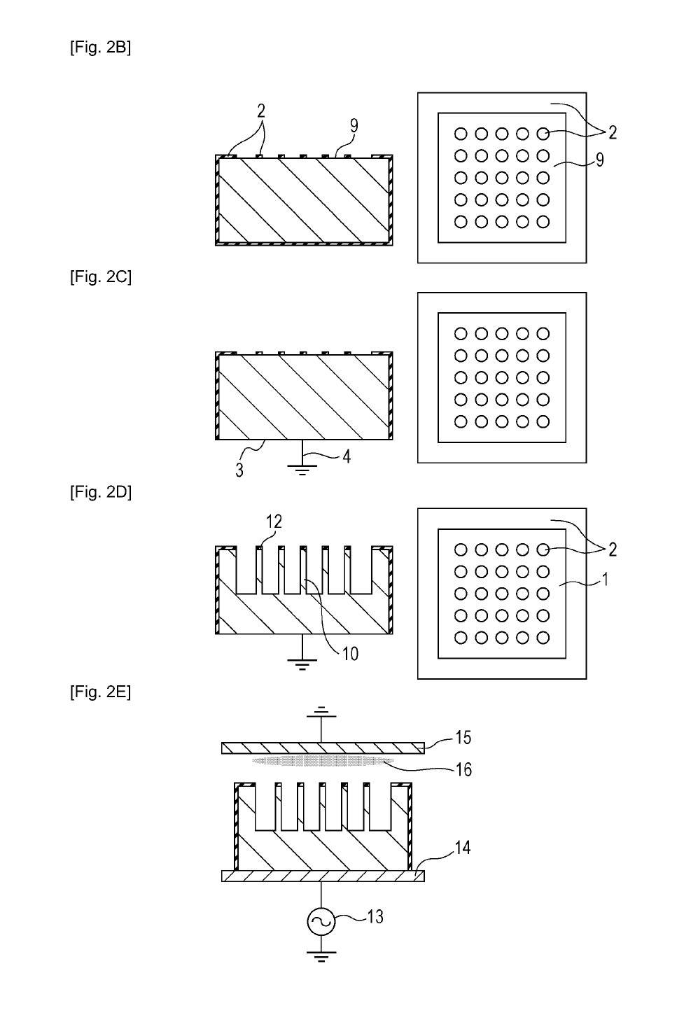

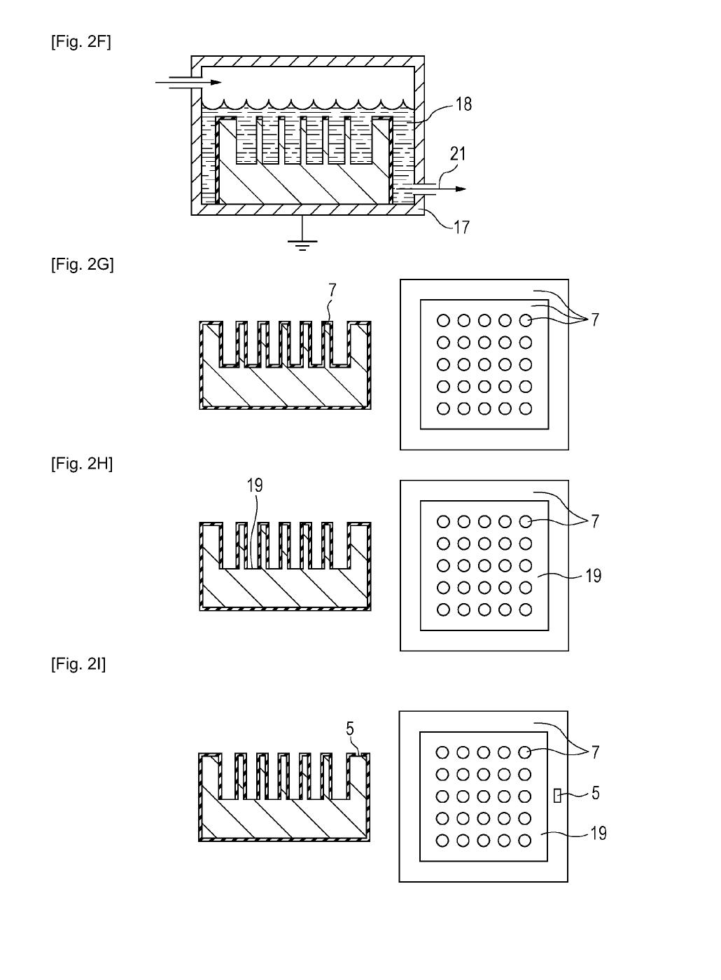

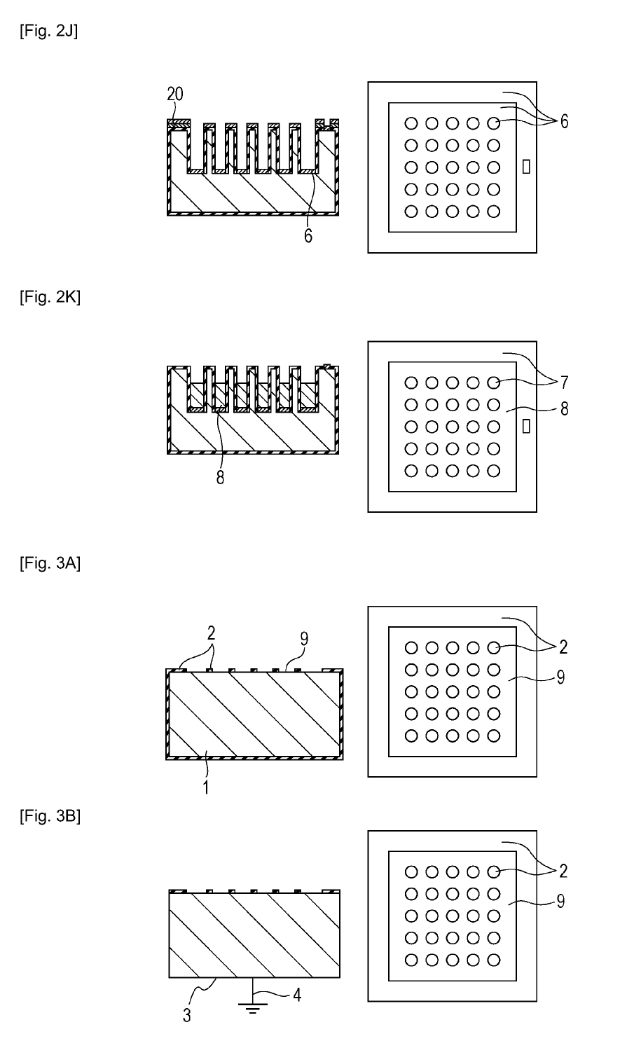

Next, a method for manufacturing a structure in the present embodiment will be described with reference to FIG. 2A to FIG. 2K.

The method for manufacturing a structure according to the present embodiment is provided with a step to form a mold with a silicon substrate 1 and a step to fill a metal 8 into the mold. In the step to form the mold with the silicon substrate, initially, a step to form a plurality of convex portions is performed by forming a recessed portion through etching of a first surface 9 of the silicon substrate 1. The plurality of convex portions are portions sandwiched between the recessed portion and are the portions left through etching. Thereafter, a step to clean the silicon substrate, a step to dry the silicon substrate, a step to form an insulating film on the silicon substrate, and a step to remove the insulating film on the bottom between the plurality of convex portions of the silicon substrate and form a seed layer are performed and, thereby, a mold is formed. Subsequently, a step to fill a metal 8 into the resulting mold is performed, so that a structure usable as a shield grating of an imaging apparatus to execute an X-ray Talbot interference method is produced.

When this manufacturing method is executed, at least part of the steps performed after the step to form the plurality of convex portions on the silicon substrate before the step to fill the metal into the mold are performed while charges of the plurality of convex portions are removed. In the present embodiment, part of the silicon substrate is the electrically conductive opening and charges of the plurality of convex portions are removed by connecting the electrically conductive opening to a ground electrode. For this purpose, a step to form an electrically conductive opening in part of the silicon substrate is performed in the step to form the mold with the silicon substrate. In this regard, a portion electrically connected to a plurality of convex portions of the silicon substrate can be used as the electrically conductive opening and, therefore, in the case where at least part of an electrically conductive surface of the silicon substrate is exposed, the exposed portion can be used as the electrically conductive opening. That is, the step to form the electrically conductive opening may be omitted insofar as at least part of the electrically conductive surface of the silicon substrate is exposed.

By the way, in the present specification, the term “charges of the plurality of convex portions are removed” also includes that charges of the plurality of convex portions are not removed completely, but the amount of charge is reduced. Furthermore, the term “the steps performed after the step to form the plurality of convex portions before the step to fill the metal into the mold” includes conveying steps as well. Examples of the conveying steps include a step to convey from the step to form the plurality of convex portions to the step to clean the silicon substrate and a step to convey from the step to form the mold to the step to fill a metal into the mold.

The method for manufacturing a structure according to the present embodiment will be described below in detail.

Initially, in order to form a mold with a silicon substrate 1, a step to form a plurality of convex portions 10 is performed by forming a recessed portion through etching of a first surface 9 of the silicon substrate. In the present embodiment, the step to form the plurality of convex portions 10 on the first surface 9 of the silicon substrate is performed while a step to form an electrically conductive opening 3 for connecting the plurality of convex portions 10 to a ground electrode 4 on the silicon substrate 1 is performed. According to this, the step to convey from the step to form the plurality of convex portions to the step to clean the silicon substrate 1 can be performed while the electrically conductive opening 3 is electrically connected to the ground electrode 4. In the present specification, a step to make preparations for etching is specified to be also included in the step to form a plurality of convex portions 10.

The silicon substrate 1 is prepared. A single crystal silicon wafer and a SOI wafer can be used for the silicon substrate 1 because high-precision working by a semiconductor process or a MEMS process becomes possible and the mechanical strength is high. The first surface 9 of the silicon substrate 1 prepared is a polished surface. In the case where the silicon substrate 1 has a size equal to a 4-inch wafer, the thickness is preferably 300 micrometers to 525 micrometers in consideration of the production process and the easiness in conveyance.

As shown in FIG. 2A, a film of a mask 2 is formed on the surface of the silicon substrate 1. In each of FIG. 2A to FIG. 2K, the left is a sectional view, and the right is a top view. The mask 2 is a mask for anisotropic etching to form a plurality of convex portions 10 on the silicon substrate and the material and the film thickness can withstand anisotropic etching. It is desirable that the mask 2 is an insulating film in consideration of filling of a metal into the recessed portion (portion between the plurality of convex portions) through electroplating in a downstream step to fill the metal. Among the insulating films, insulating films made from inorganic compounds are more desirable. This is because the insulating film made of an inorganic compound has high resistance to an organic solvent. In the case where the resistance to the organic solvent is high, dissolution does not occur easily even when an organic solvent, e.g., acetone, N,N′-dimethylformamide, or isopropyl alcohol, is used for cleaning the silicon substrate in a downstream step (a step shown in FIG. 2E). Furthermore, even when cleaning with a sulfuric acid hydrogen peroxide mixture made from sulfuric acid and aqueous hydrogen peroxide is performed, an insulator made from an inorganic compound is not dissolved easily. Moreover, even when O₂ plasma cleaning is performed, the insulator made from an inorganic compound is not dissolved easily. According to these facts, in the case where the insulating film made from the inorganic compound is used as the mask 2, cleaning with a strong cleaning power can be performed in a downstream step to clean the silicon substrate, and a function as the insulating film can be performed in the step to fill the metal. Examples of insulating films made from inorganic compounds include a silicon oxide film and a silicon nitride film. In particular, the film of SiO₂ through thermal oxidation or a film of SiN through LPCVD is preferable. In the case where the silicon substrate 1 is etched deeply, a mask having a multilayer structure, in which a metal film of Cr or the like is formed on SiO₂ or SiN, may be employed from the viewpoint of increase in selection ratio in the anisotropic etching.

As shown in FIG. 2B, the mask 2 formed as shown in FIG. 2A is patterned.

A photoresist is applied to the mask 2 formed on the first surface 9 of the silicon substrate, and an optional pattern is formed through lithography. The method for selecting the pattern depends on the shape required of the plurality of convex portions 10 formed on the silicon substrate, described later. The mask 2 is patterned by etching the mask 2 while the photoresist serves as a mask.

In the case where a film of Cr is disposed as the mask 2 on SiO₂, initially, Cr is patterned through reactive ion etching with an etching solution of Cr or a chlorine gas. Thereafter, SiO₂ is patterned through reactive ion etching with a fluorine based gas, e.g., a CHF₃ gas, so that the mask 2 is patterned.

As shown in FIG. 2C, an electrically conductive opening 3 is formed in part of the silicon substrate 1. In the silicon substrate 1, the electrically conductive opening 3 refers to a portion which is electrically connected to a plurality of convex portions 10, formed in the downstream step, of the silicon substrate and which can be connected to the ground electrode directly or indirectly. In the case where an insulating film is disposed at the portion to be provided with the electrically conductive opening 3, the insulating film may be removed. Meanwhile, an electrically conductive seed layer is formed between the plurality of convex portions 10 of the silicon substrate in order to perform electroplating in a downstream step, although the electrically conductive opening 3 is not for the purpose of seeding of the plating.

The electrically conductive opening 3 will be described.

The electrically conductive opening 3 is connected to the ground electrode 4 directly or indirectly and, thereby, has a function of reducing an influence of charges exerted on the plurality of convex portions 10 of the silicon substrate. The ground electrode is a ground potential and may be a chuck, e.g., an electrostatic chuck, in the case of a plasma process.

It is desirable that the step in which the plurality of convex portions 10 of the silicon substrate may be charged is performed while the electrically conductive opening 3 is connected to the ground electrode 4.

The steps in which the convex portions 10 are charged easily include a drying step after Wet cleaning, conveying steps between the steps, and the step by using plasma (plasma process).

In the case where these steps, in which the convex portions 10 are charged easily, are performed, mutual sticking of the convex portions due to charges of the convex portions can be reduced by connecting the electrically conductive opening 3 to the ground electrode 4. Needless to say, mutual sticking of the convex portions becomes a cause of disturbances in pitch of the plurality of convex portions 10, so that an influence is exerted on the pitch of a structure obtained by filling a metal in the downstream step. In the case where the surfaces of the convex portions 10 are covered with a native oxide as well, the convex portions 10 may be charged. Therefore, it is better to perform the above-described steps while the electrically conductive opening 3 is connected to the ground electrode 4.

In the present embodiment, as shown in FIG. 2C to FIG. 2F, the electrically conductive opening 3 is connected to the ground electrode 4 between the step to form convex portions on the silicon substrate and the step to dry the silicon substrate. However, the effect of reducing mutual sticking of the convex portions due to charges of the convex portions can be obtained by connecting the electrically conductive opening 3 to the ground electrode 4 in at least one of the steps in which the convex portions are charged easily.

In order to perform the above-described steps, in which the convex portions are charged easily, while the electrically conductive opening 3 is connected to the ground electrode 4, the step to form the electrically conductive opening is specified to be the step performed prior to the step to fill a metal serving as an X-ray absorber. In the case where the step to form the electrically conductive opening 3 is performed prior to the step to etch the first surface 9 of the silicon substrate, charges of the plurality of convex portions 10 can be reduced in a conveying step from the step to form the plurality of convex portions 10 of the silicon substrate to the step to clean the silicon substrate 1 as well.

It is desirable that the area of the insulator in the surface of the silicon substrate is minimized from the viewpoint of reduction in charge of the silicon substrate. Therefore, it is desirable that the whole second surface 11, which ensures a large area easily, of the silicon substrate serves as the electrically conductive opening 3. In this regard, the second surface 11 of the silicon substrate refers to the surface opposite to the first surface 9 of the silicon substrate. Meanwhile, in the case where the second surface 11 of the silicon substrate serves as the electrically conductive opening 3, electrical connection to the silicon substrate is ensured easily in the plasma process by using the electrostatic chuck. In the case where it is difficult to form the electrically conductive opening 3 on the second surface 11 of the silicon substrate or in the case where a SOI substrate is used as the silicon substrate, part of or an entirety of the outside of the region provided with the plurality of convex portions 10 of the first surface 9 of the silicon substrate may serve as the electrically conductive opening 3.

In the present embodiment, in order to form the electrically conductive opening 3, a film of SiO₂ formed on the second surface 11 is etched with dilute hydrofluoric acid while the first surface 9 is protected by application of a photoresist to the first surface 9. In the case where a film of Cr serving as a mask is disposed as an upper layer of SiO₂, etching of SiO₂ may be performed after the Cr film is etched by, for example, using an etching solution of Cr. The photoresist applied to protect the first surface 9 is removed.

As shown in FIG. 2D, the plurality of convex portions 10 are formed by etching the first surface 9 of the silicon substrate. Each of the plurality of convex portions 10 formed in this step is a structure having a high aspect ratio. These plurality of convex portions 10 are formed on the silicon substrate 1 while being arranged at a narrow pitch. The space between the plurality of convex portions forms a mold to be filled with a metal in the downstream step.

The cross-sectional shapes and the arrangement pattern of the plurality of convex portions 10 may be selected on the basis of the imaging system of X-ray phase imaging, the mechanical strength of the mold and the structure produced by using the mold, and the easiness in production of the structure. In the case where the two-dimensional structure, such as, the structure produced in the present embodiment, is used as the shield grating in an imaging apparatus of the X-ray Talbot interference method, the imaging system becomes a two-dimensional Talbot interference system, in which the two-dimensional information can be obtained by one time of imaging. When the structure in which the cross-sectional shapes of the plurality of convex portions are circular is compared with the structure in which the cross-sectional shapes are quadrangular, the structure in which the cross-sectional shapes are circular is easy to form the plurality of convex portions through reactive ion etching described later. On the other hand, the structure in which the cross-sectional shapes are quadrangular has high mechanical strength and can screen out X-rays ideally and selectively with respect to pixels of the detector.

Anisotropic etching can be used for etching the first surface 9. In order to perform etching at a high aspect ratio and a narrow pitch in the reactive ion etching, as in the present embodiment, a Bosch process is suitable, where etching with a SF₆ gas and deposition of a side surface protective film with a C₄F₈ gas are performed alternately. Furthermore, a wet process with an alkali solution taking advantage of the crystal orientation of the silicon substrate 1 can also be used. X-ray lithography is suitable for photolithography. The heights of the plurality of convex portions 10 are determined on the basis of the height required of a metal 8, described later, to be filled. The heights of the convex portions 10 are specified to be about 10% higher than the height required of the metal 8 and, thereby, when the metal is filled in between the plurality of convex portions, overflow of the metal from between the convex portions 10 on the basis of the filling rate difference of the metal can be prevented.

The filling height of the metal 8 changes depending on the energy of X-rays used for the X-ray imaging apparatus and the material for the metal structure. It is desirable that the metal 8 filled in between the plurality of convex portions 10 can screen out about 80% or more of the incident X-rays. For example, in the case where the energy of the X-ray is 22 key and the metal 8 is Au, it is enough that the filling height of the metal 8 is about 50 micrometers and it is desirable that the depth of the plurality of convex portions 10 is 55 micrometers or more. After the plurality of convex portions 10 are formed, the convex portions 10 are in the state of mutually sticking easily because SiO₂ and SiN of the mask formed on the top surfaces 12 of the plurality of convex portions 10 or native oxides on the surfaces of the convex portions 10 are charged. Consequently, conveyance from the step to form the plurality of convex portions 10 to the next step can be performed while the electrically conductive opening 3 is in contact with the ground electrode 4. When charges are brought close to the plurality of convex portions 10, the insulating film (SiO₂ or SiN) formed on the top surfaces of the convex portions is charged. However, charges reverse to the charge of the insulating film are collected in the vicinity of the interface between the insulating film and the convex portions 10 and, thereby, forces of the convex portions 10 to pull at each other are weakened, so that sticking can be reduced.

In the case where the pitch between the plurality of convex portions 10 is 4 micrometers or less and the aspect ratio of each of the plurality of convex portions is 20 or more, mutual sticking of the convex portions due to charges occurs significantly and easily, so that the effect of connecting the electrically conductive opening 3 to the ground electrode 4 is exerted significantly and easily.

The insulating film (SiO₂ or SiN) formed on the top surfaces 12 of the convex portions is left because a function as a mask is exerted in a downstream step.

As shown in FIG. 2E, the step to clean the silicon substrate is performed.

In the case where the plurality of convex portions 10 are formed by the Bosch process, a fluorocarbon based protective film remains on the side surfaces of the plurality of convex portions 10, so that the silicon substrate is cleaned. In the case where the insulating film is disposed on the first surface of the convex portions, it is desirable that the silicon substrate is cleaned by a cleaning method, wherein the insulating film is not dissolved. FIG. 2E shows the step to clean the silicon substrate with O₂ plasma. A high-frequency power supply 13 is used, O₂ plasma 16 is generated between a lower electrode 14 and an upper electrode 15, and cleaning is performed with the O₂ plasma. In this regard, the step to clean with O₂ plasma is shown in FIG. 2E. However, Wet cleaning with a mixed solution of sulfuric acid and hydrogen peroxide may be performed, or two types of cleaning may be performed in combination. When the plasma cleaning is performed, the electrically conductive opening may be connected to the ground electrode by connecting the electrically conductive opening to the electrostatic chuck. Consequently, charges of the plurality of convex portions 10 are reduced and mutual sticking of the plurality of convex portions 10 can be reduced.

As shown in FIG. 2F, the step to dry the silicon substrate is performed.

In the drying step after the Wet cleaning is performed, mutual sticking of the convex portions due to the surface tension of droplet can be prevented by employing supercritical drying. In a chamber 17, CO₂ 21 is introduced into the state in which the silicon substrate is immersed in isopropyl alcohol (IPA) 18 and the temperature is raised and the pressure is increased until the critical point of CO₂, that is, 31 degrees centigrade and 7.4 MPa, is exceeded. Isopropyl alcohol and CO₂ 21 are discharged while CO₂ 21 is further introduced. After isopropyl alcohol runs out of the chamber 17, the pressure is decreased to return supercritical CO₂ to gas phase CO₂.

The supercritical drying has a high effect of preventing mutual sticking of the convex portions due to the surface tension of droplet. However, the insulating film on the convex portion surface is charged because of friction with CO₂ during drying, so that mutual sticking of the convex portions due to charges may occur. Therefore, it is better to perform supercritical drying while the electrically conductive opening 3 is connected to the ground electrode 4, so as to reduce charges of the convex portion surfaces.

As shown in FIG. 2G, a step to form an insulating film 7 on the surface of the silicon substrate is performed. The method for forming the insulating film may be deposition of SiO₂ through plasma CVD or thermal oxidation. In the case where the insulating film 7 is formed on the side surfaces of the convex portions, when the metal is filled through electroplating, the metal is not deposited easily on the side surfaces of the plurality of convex portions, so that filling with reduced voids can be performed. Furthermore, the insulating film is formed on the second surface and, thereby, even when the second surface is in contact with a plating solution, precipitation of the plating on the second surface can be suppressed.

It is desirable that the film thickness of the insulating film 7 formed on the side surfaces of the convex portions is 10 nm or more. However, even when the insulating film is not formed on the side surfaces of the convex portions, deposition of the metal on the side surfaces of the convex portions can be neglected depending on the resistance of the silicon substrate, the current applied in the electroplating, or the pattern of the convex portions. In the case where an insulating film is formed on the second surface, it is desirable that the film thickness of the insulating film 7 is 10 nm or more. However, even when the insulating film is not formed on the second surface, precipitation of the plating on the second surface can be prevented by performing electroplating in such a way that the second surface does not come into contact with the plating solution. In the case where, for example, the silicon substrate is subjected to thermal oxidation, an insulating film may also be formed on the electrically conductive opening 3, and the insulating film may be etched again to form the electrically conductive opening 3 which is used for removing charges of the convex portions.

As shown in FIG. 2H, FIG. 2I, and FIG. 2J, the insulating film on the bottom 19 between the convex portions of the silicon substrate is removed and a step to form a seed is performed.

Initially, highly anisotropic reactive ion etching is performed and, thereby, the insulating film between the plurality of convex portions is removed (FIG. 2H). According to this step, the power can be supplied through the silicon substrate in an electroplating step described later and, therefore, in the silicon substrate, the metal can be filled uniformly. At this time, in order to leave the insulating film on the top surface of the convex portions of the insulating film, the insulating film having a film thickness three times or more than the film thickness of the insulating film on the bottom between the convex portions can be formed on the top surface 12 of the convex portions in advance.

Subsequent to removal of the insulating film on the bottom between the convex portions, a feeding point 5 used in the electroplating step described later is formed (FIG. 2I).

Then, a seed layer 6 is formed on the bottom 19 between the plurality of convex portions (FIG. 2J). The seed layer 6 may be produced by forming films of Cr and Cu in that order through directional electron beam evaporation.

According to the above-described steps, a silicon mold can be formed. However, the method for forming the silicon mold is not limited to that described above insofar as in the method, at least part of the steps after the step to form the plurality of convex portions on the silicon substrate to the step to fill the metal into the silicon mold are performed while charges of the plurality of convex portions are removed. For example, the step to form the insulating film shown in FIG. 2G may be omitted, or the step to form the seed layer shown in FIG. 2J may be omitted.

As shown in FIG. 2K, the metal is filled in between the plurality of convex portions.

Electroplating is employed as the method for filling the metal favorably. The power is supplied from the bottom between the plurality of convex portions 10 through the seed layer 6 and the metal 8 is filled, so that filling with reduced voids can be performed. Chemical vapor deposition (CVD), vacuum sputtering, vacuum evaporation, and the like may also be employed as the method for filling the metal. Gold, copper, nickel, iron, alloys thereof, and the like may be used as the metal to be filled. In the case where the structure is used as the shield grating, gold having a large X-ray absorption coefficient can be used.

### Second Embodiment

In a second embodiment, a method for manufacturing a one-dimensional structure will be described. The one-dimensional structure produced according to the present embodiment can be used as a one-dimensional shield grating in the X-ray Talbot interference method.

The present embodiment is different from the first embodiment in that the pattern of the patterning of the mask is in the shape of a line, and the other steps are basically the same as the steps of the first embodiment. In this regard, in the one-dimensional structure, slit-shaped metal structures, which function as screen portions, are periodically arranged. Therefore, the present embodiment is different from the first embodiment in that a plurality of recessed portions are formed by etching the first surface of the silicon substrate, so as to form a mold, and a structure is produced by filling the metal into the plurality of recessed portions of the mold. Meanwhile, even when a recessed portion in which the end portions of a plurality of recessed portions are coupled is formed, regions other than the coupled regions may be used as a one-dimensional shield grating.

### Third Embodiment

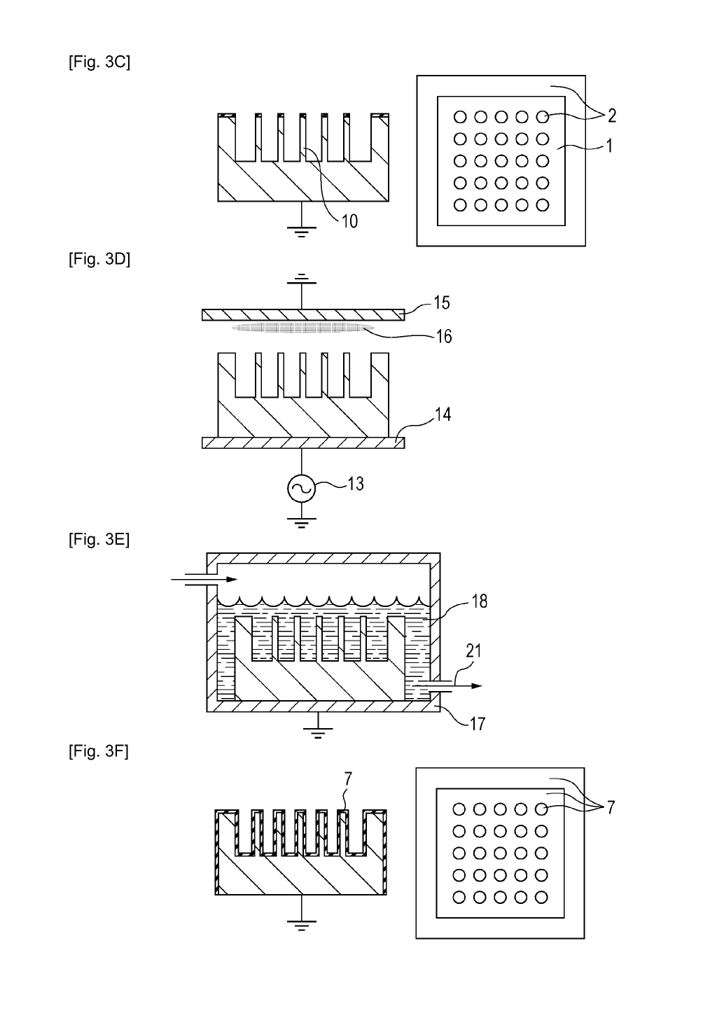

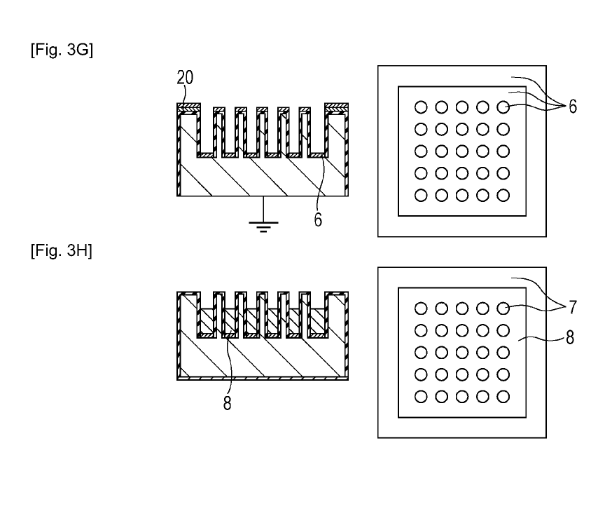

In a third embodiment, the mold and the structure produced according to the first embodiment will be described with reference to FIG. 3A to FIG. 3H. In the mold used for producing the structure of the present embodiment, a plurality of convex portions 10 are formed on the first surface 9 of the silicon substrate 1. It is desirable that the aspect ratios of the plurality of convex portions are 20 or more and 200 or less. An insulating film 7 made from an inorganic compound is formed on top surfaces 12 of the plurality of convex portions 10, and the insulating film 7 is formed on the portions excluding the bottom 19 between the plurality of convex portions. Silicon is exposed at the second surface 11 opposite to the first surface 9, and this portion, at which silicon is exposed, can be used as the electrically conductive opening. In performing the steps after the step to form the plurality of convex portions on the silicon substrate up to the step to fill the metal in between the plurality of convex portions while the silicon substrate serves as the mold, charges of the convex portions are removed by connecting the electrically conductive opening 3 of the second surface to the ground electrode. Consequently, the incidence of sticking of the convex portions of the mold is reduced and the incidence of sticking of the mold produced in the present embodiment is 0% or more and 3% or less. Furthermore, the metal is filled into at least part of portions between the convex portions of this mold and, thereby, a structure having an incidence of sticking of 0% or more and 3% or less can be produced. The incidence of sticking is minimized favorably. However, in the case of the use as the shield grating of the X-ray Talbot interference method, the incidence of sticking of 1% or less hardly exerts an influence on the information of the object.

In this regard, the incidence of sticking refers to the incidence of convex portions in contact with other convex portions among the convex portions. For example, in the case where there are 50 convex portions and sticking occurs at one place, when 2 convex portions are in contact at the one place, the incidence of sticking is 2/50*100=4%, and when 3 convex portions are in contact, the incidence of sticking is 3/50*100=6%.

As is described in PTL 1, in the case where the supercritical drying is employed, the incidence of sticking of the mold or the structure is about 5% and in the case where the silicon substrate is cleaned with alcohol and is air-dried without employing the supercritical drying, the incidence of sticking is about 70%.

The resulting structure can be used as a shield grating, in which disturbances in arrangement are reduced, in the X-ray Talbot interference method.

### Fourth Embodiment

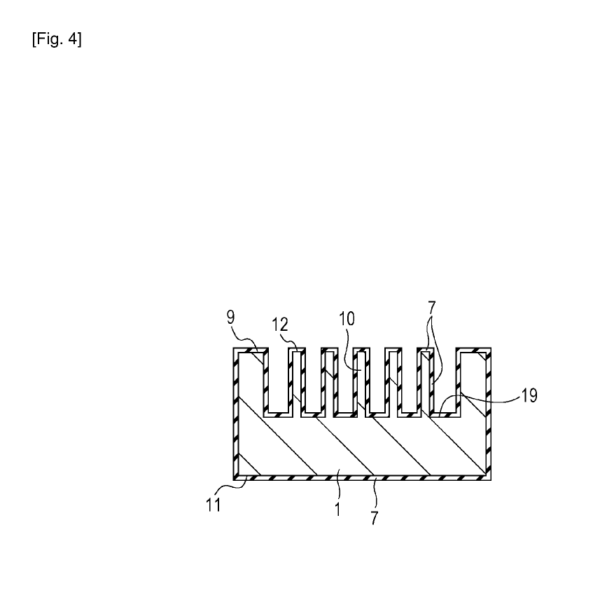

In a fourth embodiment, the structure produced in the case where an insulating film is formed on the top surfaces and side surfaces of the convex portions and the second surface in the first embodiment will be described with reference to FIG. 4.

In the structure produced according to the present embodiment, the plurality of convex portions 10 having an aspect ratio of 20 or more and 200 or less are disposed on the first surface 9 of the silicon substrate 1. The insulating film 7 is disposed on the top surfaces 12 of the plurality of convex portions 10, the side surfaces of the plurality of convex portions 10, and the second surface 11 opposite to the first surface 9. On the bottom between the plurality of convex portions, a seed layer is disposed on the surface of the silicon substrate. This silicon mold is used, the metal is filled while the seed layer serves as a seed and, thereby, a structure can be produced having the plurality of convex portions formed on the first surface of the silicon substrate and a metal body disposed in at least part of the portion between the plurality of convex portions. The aspect ratios of the plurality of convex portions are 20 or more and 200 or less and the incidence of sticking of the plurality of convex portions is 0% or more and 3% or less.

### Fifth Embodiment

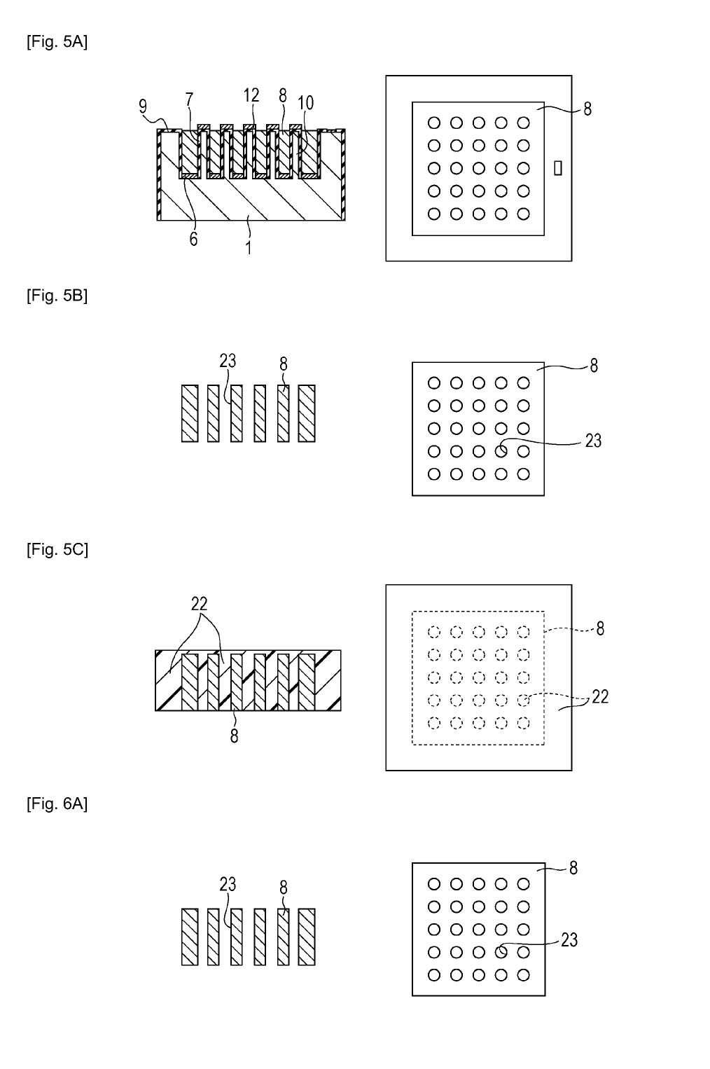

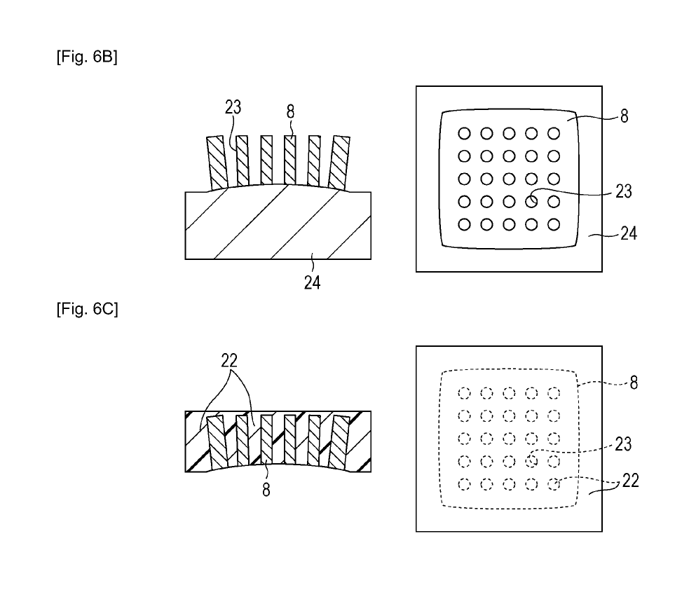

In a fifth embodiment, a method for manufacturing a structure produced from the structure which is produced in the above-described embodiment and which includes a metal body and a silicon substrate, will be described with reference to FIG. 5A to FIG. 5C. Here, the structure produced in the first embodiment is used for explanation, although the structures of the other embodiments may be used. The present embodiment includes a step to take out the metal body 8 from the structure (FIG. 5A) produced in the first embodiment (FIG. 5B) and a step to form a resin layer 22 by applying a resin to the metal body 8 taken out and solidifying the resin (FIG. 5C). The step to take out the metal body 8 is performed by etching the silicon substrate 1. The etching methods can include either wet etching or dry etching insofar as the metal body 8 filled is not etched easily. In the wet etching method, the silicon substrate 1 can be etched by using an aqueous solution made from hydrofluoric acid and nitric acid. In the case where SiO₂ or SiN is used as the insulating film 7, the insulating film 7 can also be etched by using the aqueous solution made from hydrofluoric acid and nitric acid. Alternatively, the silicon substrate 1 can be etched by using an aqueous solution of an inorganic alkali, e.g., potassium hydroxide or sodium hydroxide, or an organic alkali, e.g., tetramethylammonium hydroxide, hydrazine, or ethylenediamine. The dry etching methods include etching by using XeF as a reactive gas, where XeF is a gas which can etch silicon selectively. In the present embodiment, it is enough that the metal body is taken out of the silicon substrate 1. Therefore, part of each of the silicon substrate 1, the seed layer 6, the insulating film 7, and the like may be left on the structure of the metal body 8 taken out. The metal body 8 taken out has a structure in which high aspect ratio holes 23 are formed at places where the plurality of convex portions 10 were disposed (FIG. 5B). Subsequently, the resin is applied to the surface of the metal body taken out and the holes 23 formed in the metal body and the resin is solidified, so as to form the resin layer 22 (FIG. 5C). In the present embodiment, the resin is not necessarily filled in all holes 23, and voids may be present in the resin in the holes. The solidification in the present embodiment refers to curing of the fluid resin with ultraviolet rays, heat, catalysts, or the like. The resins can include ultraviolet-curable resins, thermosetting resins, two-part curing type resins, and the like. The strength and the handleability of the metal body 8 taken out can be improved by forming the resin layer 22 on the metal body 8. In general, the X-ray absorbance of the resin is smaller than that of the silicon substrate 1. Consequently, in the case where the structure produced according to the present embodiment is used as a shield grating in the X-ray Talbot interference method, the resulting shield grating exhibits a transmission contrast higher than that in the case where the structure in the first embodiment is used as the shield grating. Furthermore, as shown in FIG. 6A to FIG. 6C, in the case where a step to form a resin layer is performed while the metal body is deformed (FIG. 6B), the state in which the metal body is deformed can be maintained by the resin layer (FIG. 6C). In order to form the resin layer while the metal body is deformed, after the metal body 8 is coated with the resin, the metal body 8 may be deformed and the resin may be solidified. Alternatively, the resin may be applied while the metal body 8 is deformed and be solidified. For example, in the case where the X-ray Talbot interference method by using divergent X-rays is executed, if the shield grating is in a planar shape, eclipse occurs depending on the incident angle of the X-rays. In order to prevent this, a shield grating curved into an R-shape or a spherical R-shape may be used. In the present embodiment, the above-described eclipse of the X-rays can be reduced by forming the resin layer while the metal body taken out of the silicon substrate is curved into an R-shape or a spherical R-shape.

In the case where the resin layer is formed while the metal body is deformed into an R-shape, the directions of the plurality of holes disposed in the metal body in the depth direction become the directions reflecting the R-shape. Meanwhile, in the case where the resin layer is formed while the metal body is deformed into a spherical R-shape, the directions of the plurality of holes of the metal body in the depth direction can be made directions concentrated on one point on an extension of the plurality of holes. Here, the R-shape refers to a shape of a circular cylinder cut in the depth direction, and the spherical R-shape refers to a continuous curved surface in the shape of a sphere.

For example, a method in which the metal body is brought into contact with a mold directly or indirectly, so as to be deformed, can be employed as the method for deforming the metal body.

According to the present embodiment, as shown in FIG. 5C, the metal body, which is provided with the plurality of holes 23 having an aspect ratio of 20 or more and which is made from gold or an alloy thereof, and the structure provided with the resin layer formed on at least part of the surface of the metal body and at least part of the holes disposed in the metal body are obtained. In the case where the resin layer is formed while the metal body is deformed, the structure reflecting the deformation is obtained, as shown in FIG. 6C. For example, when the resin layer is formed while the metal body is deformed into an R-shape or a spherical R-shape, the directions of the holes 23 disposed in the metal body in the depth direction become the directions reflecting the R-shape or the spherical R-shape.

Meanwhile, if the metal bodies are coupled to each other in the one-dimensional structure shown in the second embodiment, it is possible that the metal bodies are taken out by the above-described method, and the resin layer is formed after deformation.

In the present embodiment, the holes 23 formed in the metal body are through holes, although the holes 23 may not penetrate the metal body 8. For example, when the metal is filled through electroplating, if the top surface of the metal exceeds the top surfaces of the convex portions, the holes become not through holes. The present embodiment can also be applied to such a structure.

### Example 1

In Example 1, the method for manufacturing the structure according to the first embodiment will be described in more detail.

As in the first embodiment, the present example will be described with reference to FIG. 2A to FIG. 2K. The mold is formed from the silicon substrate 1 in the steps shown in FIG. 2A to FIG. 2J, and the metal is filled into the mold in the step shown in FIG. 2K. Each of the steps will be described below.

In the step shown in FIG. 2A, the film of the mask 2 is formed on the silicon substrate 1. The single-sided polished silicon substrate 1 having a diameter of 4 inches and a thickness of 525 micrometers is prepared. The mask 2 made from a multilayer of Cr and SiO₂ is formed on the first surface 9 of the silicon substrate 1. In the method for forming the mask 2, initially, a SiO₂ film having a film thickness of 500 nm is deposited on the silicon substrate 1 through thermal oxidation. Thereafter, 200 nm of Cr is deposited through electron beam evaporation, so that the mask 2 made from a multilayer of Cr and SiO₂ can be formed.

As shown in FIG. 2B, the mask 2 formed is patterned. A photoresist is applied to the mask on the first surface 9 of the silicon substrate, and an optional pattern is formed through lithography. The remaining resist serves as a mask, and Cr is patterned through reactive ion etching with an etching solution of Cr or a chlorine gas. Subsequently, SiO₂ is patterned through reactive ion etching with a fluorine based gas, e.g., a CHF₃ gas. In the pattern of the mask 2 of the present example, dots having a diameter of 1.75 micrometers are arranged in the shape of a grating at an interval of 1.75 micrometers in an area 60 mm square.

As shown in FIG. 2C, the electrically conductive opening 3 is formed in part of the silicon substrate 1. In the present example, the whole second surface 11 of the silicon substrate serves as the electrically conductive opening 3. The whole second surface 11 is specified to be the electrically conductive opening 3 by etching SiO₂ on the second surface 11 with dilute hydrofluoric acid while the first surface 9 of the silicon substrate 1 is protected by the photoresist.

In the step shown in FIG. 2D, the plurality of convex portions 10 are formed by subjecting the silicon substrate 1 to anisotropic etching while the dot pattern mask formed in the step shown in FIG. 2B serves as a mask. The Bosch process is employed, where etching with a SF₆ gas and deposition of a side surface protective film with a C₄F₈ gas are performed alternately, and etching is performed in such a way that the heights of the convex portions become 55 micrometers or more. After the convex portions 10 are formed, the convex portions are in the state of mutually sticking easily because SiO₂ on the top surfaces of the convex portions 10 or native oxides on the surfaces of the convex portions 10 are charged. Consequently, conveyance performed after formation of the convex portions 10 until filling of the metal into the mold is performed while the electrically conductive opening 3 is in contact with the ground electrode 4.

In the step shown in FIG. 2E, the silicon substrate 1 is cleaned. Cleaning is performed by combining O₂ plasma cleaning and Wet cleaning with a mixed solution of sulfuric acid and hydrogen peroxide. When the plasma cleaning is performed, the electrically conductive opening 3 is brought into contact with the electrostatic chuck. Likewise, the Wet cleaning is performed while the electrically conductive opening 3 is connected to the ground electrode 4. In this regard, SiO₂ on the top surfaces of the convex portions 10 is left because a function as a mask is exerted in a downstream step.

Supercritical drying of the silicon substrate 1 is performed in the step shown in FIG. 2F. In a chamber, CO₂ is introduced into the state in which the silicon substrate 1 is immersed in IPA, and the temperature is raised and the pressure is increased until the critical point of CO₂ is exceeded. Isopropyl alcohol and CO₂ are discharged while CO₂ is further introduced. After IPA runs out of the chamber, the pressure is decreased to return supercritical CO₂ to gas phase CO₂.

The supercritical drying is performed while the electrically conductive opening 3 is connected to the ground electrode 4, so that charges of the convex portions are reduced.

The insulating film is formed on the surface of the silicon substrate 1 in the step shown in FIG. 2G. The silicon substrate 1 is subjected to thermal oxidation and, thereby, silicon oxide having a film thickness of 100 nm is deposited on the side surfaces of the convex portions. The film thickness of the insulating film becomes larger than 100 nm because the film of SiO₂ formed in the step shown in FIG. 2A remains on the top surfaces 12 of the convex portions.

The insulating film formed on the bottom 19 between the convex portions is etched to expose Si in the step shown in FIG. 2H. Dry etching by using a CHF₃ gas is performed while SiO₂ on the top surfaces 12 of the convex portions serves as a mask, so as to remove the film of SiO₂ formed on the bottom 19 between the convex portions. The surface of the silicon substrate comes into the state of being covered with SiO₂ excluding the bottom 19 between the convex portions.

Part of the insulating film 7 formed in the step shown in FIG. 2G is removed with a HF solution or the like in the step shown in FIG. 2I, so as to form a feeding point 5 for the electroplating.

The seed layer 6 is formed on the bottom 19 between the convex portions in the step shown in FIG. 2J. The seed layer 6 is formed and, thereby, the metal is filled through electroplating uniformly and easily. The seed layer 6 is produced by forming films of Cr of 10 nm and Cu of 120 nm in that order through directional electron beam evaporation. The portion other than the region provided with the convex portions (other than the region 60 mm square) excluding the feeding point 5 is covered with a protective mask 20, e.g., a Kapton tape. The protective mask 20 may be peeled off after the electron beam evaporation.

The seed layer is also formed on the top surfaces of the convex portions because of adhesion of Cr and Cu through the electron beam evaporation. However, in the case where the film is formed perpendicularly to the silicon substrate 1 through directional electron beam evaporation, there is no continuity between the seed layer on the top surfaces of the convex portions and the seed layer 6 on the bottom between the convex portions.

In the step shown in FIG. 2K, the power is supplied from the feeding point 5, and Au is filled from the bottom 19 between the convex portions formed on the silicon substrate through electroplating. In the case where the electrically conductive opening 3 remains on the silicon substrate 1, masking is performed with tape, resist, or the like resistant to the plating solution in such a way that the plating does not deposit on the electrically conductive opening 3. Au plating does not grow from the seed layer on the top surfaces of the convex portions.

### Example 2

In Example 2, an example, which is different from Example 1, of the method for manufacturing the structure according to the first embodiment will be described with reference to FIG. 3A to FIG. 3H. In each of FIG. 3A to FIG. 3H, the left is a sectional view and the right is a top view as with FIG. 2A to FIG. 2K.

The present example is different from Example 1 in that CVD is employed for formation of the insulating film, and an insulating film is not formed on the second surface.

In the step shown in FIG. 3A, as in Example 1, the film of the mask 2 is formed by forming a SiO₂ film having a film thickness of 500 nm and a Cr film having a film thickness of 200 nm on the first surface 9 of the single-sided polished silicon substrate 1 having a diameter of 4 inches and a thickness of 525 micrometers. Furthermore, as in Example 1, the mask 2 is patterned. In a mask pattern area 60 mm square, as in Example 1, the dot structures having a diameter of 1.75 micrometers are arranged in the shape of a grating at an interval of 1.75 micrometers.

In the step shown in FIG. 3B, as in Example 1, the second surface 11 of the silicon substrate 1 serves as the electrically conductive opening 3 and is brought into the contact with the ground electrode 4.

In the step shown in FIG. 3C, the plurality of convex portions 10 are formed by subjecting the silicon substrate 1 to anisotropic etching while the Cr film of the mask formed in the step shown in FIG. 3A serves as a mask. As in Example 1, the anisotropic etching is performed by the Bosch process.

In the step shown in FIG. 3D, the silicon substrate 1 is cleaned and the mask 2 is removed. In the cleaning method, as in Example 1, O₂ plasma cleaning and Wet cleaning with a mixed solution of sulfuric acid and hydrogen peroxide are performed in combination. As in Example 1, this step is performed while the electrically conductive opening 3 is connected to the ground electrode 4.

In the step shown in FIG. 3E, as in Example 1, a supercritical drying step after Wet cleaning is performed.

In the step shown in FIG. 3F, the insulating film is formed by depositing silicon oxide having a film thickness of 100 nm through plasma CVD on the side surfaces of the plurality of convex portions disposed on the silicon substrate.

In the step shown in FIG. 3G, Si is exposed at the bottom between the convex portions and the seed layer 6 is formed. The seed layer 6 is formed in the same manner as that in Example 1. In the present example, an insulating film is not disposed on the second surface and, therefore, charges of the plurality of convex portions can be removed in the present step or in the conveying steps which are the steps before and after the present step.

In the step shown in FIG. 3H, Au is filled from the bottom between the convex portions through electroplating. The power is fed from the seed layer 6. In the same manner as that in Example 1, in which the portion other than the region provided with the convex portions is covered with the protective mask, in the present example as well, masking of the portion other than the region provided with the convex portions and the electrically conductive opening 3 is performed with tape, resist, or the like, which serves as a protective mask, resistant to the plating solution.

### Example 3

In Example 3, another concrete example of the structure according to the first embodiment will be described. The present example is different from Example 1 in that the step to form the insulating film shown in FIG. 2G is not included, and the metal to be filled is nickel.

In the present example, a silicon substrate 1 having a thickness of 525 micrometers and a diameter of 100 mm is used. Etching is performed in such a way that convex portions 10 having a diameter of 2 micrometers are formed while being arranged at a pitch of 4 micrometers in a region 50 mm square on the first surface 9 of this silicon substrate. The heights of the convex portions 10 is 70 micrometers, a SiO₂ layer having a thickness of 0.5 micrometers and serving as an insulating film 7 made from an inorganic compound is formed on the top surfaces 12 of the convex portions 10, and the aspect ratios are about 35. An electrically conductive surface of the silicon substrate is exposed at the second surface 11 opposite to the first surface 9. Charges of the convex portions 10 can be removed efficiently by connecting the electrically conductive surface of the second surface 11 serving as the electrically conductive opening to the ground electrode. After etching, the silicon substrate is subjected to O₂ plasma cleaning. The O₂ plasma cleaning is performed at 1,400 W, a pressure of 0.6 Torr, and an oxygen flow rate of 300 sccm for 600 seconds. Charges generated by collision of plasma with the convex portions 10 are removed from the electrically conductive opening of the second surface 11. Consequently, mutual sticking of adjacent convex portions 10 due to static electricity can be suppressed and disturbance in arrangement of the convex portions 10 can be suppressed. Connection of the electrically conductive opening to the ground electrode in drying of the silicon substrate after the Wet cleaning exerts a charge removing effect with respect to charges, which occur in drying, of the convex portions. For example, instead of the O₂ plasma cleaning, the silicon substrate may be subjected to cleaning with a mixed solution of sulfuric acid and hydrogen peroxide, rinsing with pure water, immersion in isopropyl alcohol, and supercritical drying by using CO₂.

The seed layer 6 is formed on the bottom 19 between the convex portions 10 of the structure. The seed layer 6 is produced by forming films of Cr of 10 nm and Cu of 120 nm in that order through directional electron beam evaporation. This is used as a silicon mold, and nickel is filled through electroplating. Energization for the electroplating is performed from the silicon surface of the second surface exposed at the plating solution. A nickel sulfamate plating solution is used as the plating solution. In the structure of the present example, the metal is filled into the silicon mold produced by suppressing mutual sticking of adjacent convex portions due to static electricity and, therefore, disturbance in arrangement of the metal body can also be suppressed.

### Example 4

In Example 4, the structure according to the fourth embodiment will be described more concretely with reference to FIG. 4. The structure of the present example is produced by using a silicon substrate 1 having a thickness of 525 micrometers and a diameter of 100 mm. A pattern, in which a plurality of convex portions 10 having a diameter of 2 micrometers are arranged in the shape of a grating at a pitch of 4 micrometers, is disposed in a region 50 mm square on the first surface 9 of the silicon substrate 1. The heights of the convex portions 10 is 70 micrometers, a SiO₂ layer having a thickness of 0.4 micrometers is disposed on the top surfaces of the convex portions 10, and the aspect ratios of the convex portions are about 35. A SiO₂ layer having a thickness of about 10 nm is disposed as an insulating layer on the side surfaces of the convex portions 10. A SiO₂ layer having a thickness of about 10 nm is also disposed on the second surface 11 opposite to the first surface 9. On the bottom between the convex portions, a seed layer is disposed on the surface of the silicon substrate. A metal film in which Cr of 5 nm and Au of 100 nm are formed in that order is used as the seed layer in the present example. A metal body is disposed on the seed layer, and the metal body is disposed in at least part of portion between the plurality of convex portions included in the structure of the present example.

The method for manufacturing the structure of the present example up to the supercritical drying of the silicon substrate is the same as that in Example 3. As in Example 3, the silicon substrate after etching is subjected to O₂ plasma cleaning and cleaning with a mixed aqueous solution of sulfuric acid and aqueous hydrogen peroxide, rinsing with pure water, immersion in isopropyl alcohol, and supercritical drying by using CO₂. Subsequently, the whole surface of the silicon substrate is subjected to thermal oxidation by being put into a thermal oxidation furnace. The thickness of a thermally grown oxide film formed at this time is about 10 nm. Consequently, the thermally grown oxide film serving as an insulating film can be formed on both a recessed portion and the second surface 11 at the same time. The insulating film 7 is formed on the second surface 11 as well and, thereby, deposition of the plating on the second surface 11 is suppressed in plating in a downstream step.

The insulating film formed on the bottom between the convex portions is removed through anisotropic etching, and the seed layer 6 is formed. In the formation of the seed layer 6, films of Cr of 5 nm and Au of 100 nm are formed in that order through directional electron beam evaporation. Silicon of part of the second surface 11 exposed at the plating solution is exposed and energization is performed. A weak alkaline cyan-free Au plating solution is used as the plating solution. In this manner, Au plating grows from the seed layer 6, and a metal body made from gold can be formed by filling gold in between the convex portions. The insulating film 7 having a sufficient thickness is disposed on the side surfaces of the convex portions and the second surface 11, so that even when the insulating film 7 is dissolved into the weak alkaline plating solution to some extent, the side surfaces of the convex portions and the surface of silicon of the second surface 11 are not exposed. Therefore, precipitation of the plating on the side surfaces of the convex portions and the second surface can be suppressed until the Au plating is finished. Consequently, a two-dimensional structure can be produced while disturbances in arrangement of the convex portions 10 caused by sticking due to charges of the convex portions and poor plating in filling of the metal in between the convex portions are suppressed.

### Example 5

In Example 5, the method for manufacturing the structure according to the fifth embodiment will be described more concretely with reference to FIG. 5A to FIG. 5C. The structure shown in FIG. 5A is produced by the same manufacturing method as that in Example 1. In the structure shown in FIG. 5A, a plurality of circular columnar convex portions having a diameter of 4 micrometers are disposed at a pitch of 8 micrometers in a region 90 mm square on the first surface 9 of the silicon substrate 1, and a metal body is disposed by filling gold in between the plurality of convex portions. The silicon substrate 1 is a silicon substrate having a thickness of 625 micrometers and a diameter of 150 mm. The height of the metal body 8 is 120 micrometers. The insulating film 7 is specified to be a SiO₂ film and the seed layer 6 is specified to be a metal film of copper. This structure is immersed in an aqueous solution made from hydrofluoric acid and nitric acid, so that the silicon substrate 1 is etched and the metal body 8 formed by being filled in between the plurality of convex portions 10 is taken out. In the case where the aqueous solution made from hydrofluoric acid and nitric acid is used, the insulating film 7 (SiO₂ film) and the seed layer 6 (metal film of copper) are etched at the same time. After etching is finished, the metal body 8 is taken out into an aqueous solution made from hydrofluoric acid and nitric acid (FIG. 5B). Silicon of the convex portions 10 is etched and, thereby, a plurality of holes 23 having a diameter of 4 micrometers are formed in the metal body 8. The aspect ratio of the hole 23 is 30. The sticking of the convex portions is suppressed and, thereby, disturbances in arrangement of the holes generated by contact of the holes with each other can also be suppressed. The metal body 8 taken out is placed on a polyethylene terephthalate (PET) film, and an ultraviolet-curable resin TB3114 (ThreeBond Co., Ltd.) is applied thereto. A quartz substrate coated with EGC-1720 (Sumitomo 3M Limited) serving as a mold release agent is placed on the metal body coated with the ultraviolet-curable resin, and ultraviolet rays are applied, so as to cure the ultraviolet-curable resin. Thereafter, the quartz substrate is peeled off, so that a metal body reinforced with a resin layer is obtained on the PET film, although not shown in the drawing (FIG. 5C).

### Example 6

In Example 6, the method for manufacturing the structure according to the fifth embodiment will be described more concretely with reference to FIG. 6A to FIG. 6C. The present example is different from Example 5 in that the resin layer is formed while the metal body is curved into a spherical R-shape. The method up to the taking out of the metal body 8 (FIG. 6A) is the same as that in Example 5. In the present example, a mold 24 of convex type in the spherical R-shape having a radius of 2 m and having a continuous curved surface in the shape of a sphere is used. When an aqueous solution of a surfactant is applied to the mold and the metal body 8 taken out is placed on the mold 24, the metal body 8 is stuck on the mold because of the surface tension of the aqueous solution of the surfactant, and is deformed into the shape reflecting the shape of the mold 24 (FIG. 6B). Subsequently, the ultraviolet-curable resin used in Example 5 is applied to the metal body 8 on the mold 24. A quartz substrate coated with a mold release agent is placed thereon, and ultraviolet rays are applied, so as to cure the ultraviolet-curable resin. Thereafter, the metal body 8 is released from the quartz substrate and the mold 24, so that a metal body 8 having a radius of 2 m and having a continuous curved surface in the shape of a sphere is obtained. The shape having the continuous curved surface of the metal body is held by the resin layer. In the metal body with a curve maintained by the resin layer, the directions of the holes 23 in the depth direction become directions reflecting the shape of the mold 24. Consequently, the directions of the plurality of holes 23 of the structure having a continuous curved surface in the shape of a sphere of the metal body 8 in the depth direction are concentrated on one point on an extension. The directions of the holes in the depth direction become as described above and, therefore, a structure having a favorable shape as the shield grating of divergent X-rays is obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-192816, filed Sep. 5, 2011 and No. 2012-155512, filed Jul. 11, 2012, which are hereby incorporated by reference herein in their entirety.

### REFERENCE SIGNS LIST

1 Silicon substrate
3 Electrically conductive opening
4 Ground electrode
8 Metal body
9 First surface
10 Convex portion
11 Second surface
12 Top surface of convex portion
22 Resin layer
23 Hole
24 Mold

1. A method for manufacturing a structure, comprising the steps of:
forming a recessed portion in a silicon substrate;
cleaning, drying, or conveying the silicon substrate while charges of a plurality of portions sandwiched between the recessed portion are removed; and
filling a metal into the recessed portion of the silicon substrate subjected to the cleaning, drying, or conveying.

2. The method for manufacturing a structure according to claim 1, wherein an electrically conductive opening electrically connected to the plurality of portions sandwiched between the recessed portion is disposed in the silicon substrate, and charges of the plurality of portions sandwiched between the recessed portion are removed by electrically connecting the electrically conductive opening to a ground electrode.

3. The method for manufacturing a structure, according to claim 1,
wherein a plurality of convex portions are formed on the silicon substrate by forming the recessed portion, and
the portions sandwiched between the recessed portion are the plurality of convex portions formed on the silicon substrate.

4. The method for manufacturing a structure, according to claim 3,
wherein the plurality of convex portions are arranged at a pitch of 4 micrometers or less, and
the aspect ratio of each of the plurality of convex portions is 20 or more.

5. The method for manufacturing a structure, according to claim 3, wherein the plurality of convex portions are two-dimensional arranged.

6. The method for manufacturing a structure, according to claim 1, wherein in the forming of recessed portion in the silicon substrate, a plurality of recessed portions are formed in the silicon substrate.

7. The method for manufacturing a structure, according to claim 5,
wherein the plurality of recessed portions are arranged at a pitch of 4 micrometers or less, and
the aspect ratio of each of the plurality of recessed portions is 20 or more.

8. A structure comprising:
a plurality of convex portions disposed on a first surface of a silicon substrate; and
a metal body disposed in at least part of portion between the plurality of convex portions,
wherein the aspect ratios of the plurality of convex portions are 20 or more and 200 or less, and
the incidence of sticking of the plurality of convex portions is 0% or more and 3% or less.

9. A structure comprising:
a silicon substrate provided with a plurality of recessed portions in a first surface; and
a metal body disposed in at least part of the plurality of recessed portions,
wherein the aspect ratio of each of the plurality of recessed portions are 20 or more and 200 or less, and
the incidence of sticking of the portions sandwiched between the plurality of recessed portions is 0% or more and 3% or less.

10. The structure according to claim 8, comprising an electrically conductive opening electrically connected to the plurality of convex portions.

11. The structure according to claim 10,
wherein an insulating film is disposed on the top surfaces of the plurality of convex portions, and
the electrically conductive opening is disposed by exposing at least part of a second surface opposite to the first surface of the silicon substrate.

12. A metal body made from gold or an alloy thereof, comprising a plurality of holes having an aspect ratio of 20 or more, wherein the incidence of sticking of the plurality of holes is 0% or more and 3% or less.

13. The metal body according to claim 12, comprising a resin layer disposed on at least part of the plurality of holes or the metal body surface.

14. An X-ray imaging apparatus comprising:
a diffraction grating to diffract X-rays from an X-ray source and form an interference pattern;
a shield grating to screen out part of the X-rays to form the interference pattern; and
a detector to detect X-rays from the shield grating,
wherein the shield grating has the metal body according to claim 12.

15. The structure according to claim 9, comprising an electrically conductive opening electrically connected to the portions sandwiched between the plurality of recessed portions.

16. The structure according to claims 15,
wherein an insulating film is disposed on the top surfaces of the portions sandwiched between the plurality of recessed portions, and
the electrically conductive opening is disposed by exposing at least part of a second surface opposite to the first surface of the silicon substrate.

17. An X-ray imaging apparatus comprising:
a diffraction grating to diffract X-rays from an X-ray source and form an interference pattern;
a shield grating to screen out part of the X-rays to form the interference pattern; and
a detector to detect X-rays from the shield grating,
wherein the shield grating has the metal body according to claim 13.
